(19) United States
(12) Patent Application Publication
(10) Pub. No.: US 2020/0388969 A1
(43) Pub. Date: Dec. 10, 2020

(54) BASE BOARD MODULE

(71) Applicant: Mitsubishi Electric Corporation, Tokyo (JP)

(72) Inventors: Yuki OKANAMI, Tokyo (JP); Hiroshi ITAKURA, Tokyo (JP); Yoshihiro AKEBOSHI, Tokyo (JP)

(73) Assignee: Mitsubishi Electric Corporation, Tokyo (JP)

(21) Appl. No.: 16/481,151

(22) PCT Filed: Mar. 8, 2017
(86) PCT No.: PCT/JP2017/009226

§ 371 Date: Jul. 26, 2019

(51) Int. Cl. H01R 24/50; H01R 12/72; H01R 13/6594

(52) U.S. Cl. CPC H01R 24/50; H01R 24/42; H01R 13/6594; H01R 12/722

(57) ABSTRACT

A printed circuit board (3) includes a conductor-less area (30) in which a conductor is excluded over an entire edge on a side to which a coaxial connector (2) is attached. An end of a core wire (22) is brought into contact with a signal pad (35) in a state of being covered with a second ground conductor portion (21) of the coaxial connector (2) attached to the conductor-less area (30).

### TECHNICAL FIELD

The present invention relates to a base board module provided with a printed circuit board on which a coaxial connector is mounted.

### BACKGROUND ART

Conventionally, a coaxial connector is often used to keep a good transmission characteristic in transmission of a high frequency signal a frequency of which exceeds GHz.

As a usage mode of the coaxial connector, there is a base board module in which the coaxial connector is attached to an edge of a printed circuit board. In this base board module, when an electrode structure is different between the coaxial connector and the printed circuit board, the transmission characteristic is degraded due to unmatched reflection in a high frequency domain.

For example, an attachment disclosed in Patent Literature 1 is a base board module in which a coaxial connector is covered with a conductive cover, and a quasi-coaxial transmission line is provided on a surface layer of a circuit board on which the coaxial connector is mounted. The quasi-coaxial transmission line is a transmission line obtained by covering a central conductor with a dielectric layer. A thickness of the dielectric layer is changed so that a position of the central conductor of the quasi-coaxial transmission line matches a position of a central conductor of the coaxial connector.

### CITATION LIST

### Patent Literature

Patent Literature 1: JP 2003-208950 A

### SUMMARY OF INVENTION

### Technical Problem

In the base board module disclosed in Patent Literature 1, in order to match characteristic impedances in transmission from the coaxial connector to the transmission line of the circuit board, it is necessary to appropriately design the thickness of the dielectric layer of the quasi-coaxial transmission line. Such design of a wiring layer of a printed circuit board generally requires a detailed study using three-dimensional electromagnetic field analysis. Thus, it is up to technical skill of a designer whether a base board module with a good transmission characteristic can be obtained. For example, when changing the printed circuit board in the conventional base board module, in order to keep the transmission characteristic good, it is necessary to redesign the wiring layer of the printed circuit board, which may cause a difference in the transmission characteristic due to a difference in designer.

The present invention solves the above-described problem, and an object thereof is to obtain a base board module capable of omitting detailed design of a printed circuit board and keeping the transmission characteristic good.

### Solution to Problem

A base board module according to the present invention is provided with a coaxial connector and a printed circuit board.

The coaxial connector includes a first ground conductor portion which is a cylindrical conductor member and an inside of which is provided with a core wire for a coaxial cable and a second ground conductor portion which is a semi-cylindrical conductor member extending in an axial direction of the first ground conductor portion from the first ground conductor portion and covers an end of the core wire. The printed circuit board includes a signal pad, a signal wire electrically connected to the signal pad, and a conductor-less area in which a conductor is excluded over an entire edge on a side to which the coaxial connector is attached.

In this configuration, the coaxial connector is attached to the conductor-less area, and the end of the core wire is brought into contact with the signal pad in a state of being covered with the second ground conductor portion of the coaxial connector attached to the conductor-less area.

### Advantageous Effects of Invention

According to the present invention, since the coaxial connector is attached to the area in which the conductor is excluded over the entire edge of the printed circuit board, detailed design of the printed circuit board in consideration of an effect of the conductor of the edge on a characteristic of the signal wire can be omitted. Furthermore, the transmission characteristic can be kept good because signal transmission in which characteristic impedances of the coaxial cable, the coaxial connector, and the printed circuit board are matched can be achieved just by design of the coaxial connector.

### BRIEF DESCRIPTION OF DRAWINGS

FIG. 1 is a perspective view illustrating a base board module according to a first embodiment of the present invention.

FIG. 2 is an exploded perspective view illustrating the base board module according to the first embodiment.

FIG. 3 is a plan view illustrating a printed circuit board as seen in an arrow A direction in FIG. 2.

FIG. 4 is a plan view illustrating the printed circuit board as seen in an arrow B direction in FIG. 2.

FIG. 5 is a plan view illustrating another printed circuit board as seen in the arrow A direction in FIG. 2.

FIG. 6 is a graph illustrating a relationship between a reflection characteristic and a frequency.

FIG. 7 is a cross-sectional view illustrating a base board module according to a second embodiment of the present invention.

FIG. 8 is a cross-sectional view illustrating a base board module according to a third embodiment of the present invention.

### DESCRIPTION OF EMBODIMENTS

Modes for carrying out the present invention are hereinafter described with reference to the attached drawings in order to describe the present invention in more detail.

### First Embodiment

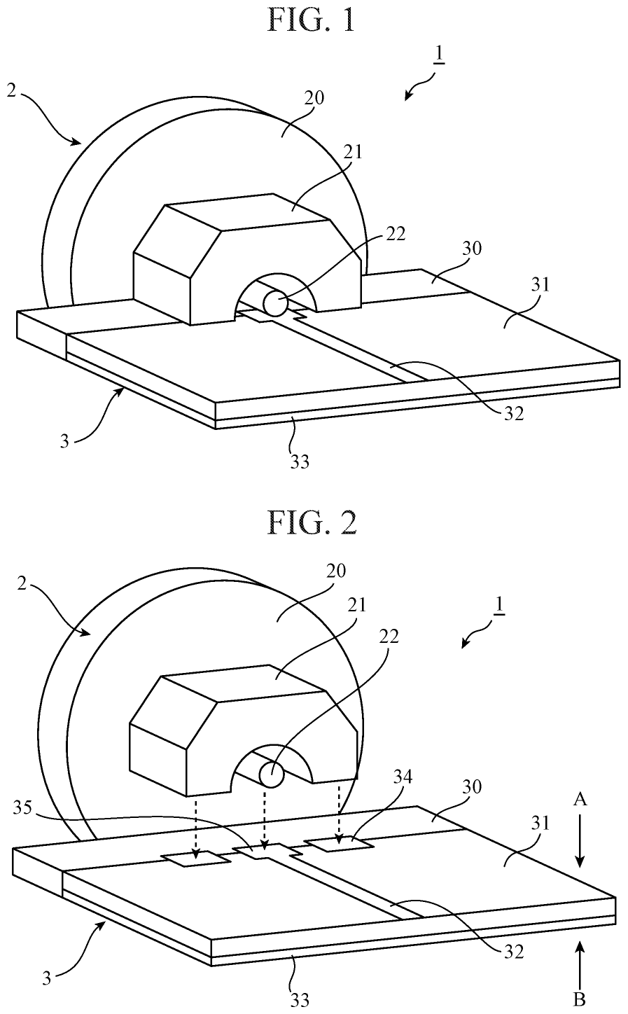

FIG. 1 is a perspective view illustrating a base board module 1 according to a first embodiment of the present invention. FIG. 2 is an exploded perspective view illustrating the base board module 1, illustrating a state in which a coaxial connector 2 is detached from a printed circuit board 3. The base board module 1 is provided with the coaxial connector 2 and the printed circuit board 3 as illustrated in FIG. 1. The coaxial connector 2 is provided with a first ground conductor portion 20, a second ground conductor portion 21, and a core wire 22. The printed circuit board 3 is provided with a conductor-less area 30, a wiring area 31, a signal wire 32, a base board ground 33, ground pads 34, and a signal pad 35.

In the coaxial connector 2, the first ground conductor portion 20 is a cylindrical conductor member with the core wire 22 provided inside thereof, and is electrically connected to a shield member (not illustrated) of a coaxial cable to have ground potential. The shield member of the coaxial cable is an outer conductor provided around the core wire 22 which is a central conductor. The second ground conductor portion 21 is a semi-cylindrical conductor member which extends in an axial direction of the first ground conductor portion 20 from the first ground conductor portion 20 to cover the core wire 22 and has the ground potential. An end of the core wire 22 protrudes from the first ground conductor portion 20 and is covered with the second ground conductor portion 21.

In the printed circuit board 3, as illustrated in FIG. 2, the conductor-less area 30 is an area in which a conductor of a first layer (surface layer) is excluded over an entire edge on a side to which the coaxial connector 2 is attached. The wiring area 31 is an area which is provided on the first layer of the printed circuit board 3 and on which a wiring pattern including the signal wire 32 is formed. The signal wire 32 is a wire for signal transmission and is electrically connected to the signal pad 35. The base board ground 33 is a solid pattern of the ground potential provided on a second layer (back layer) of the printed circuit board 3.

The ground pads 34 are provided on the first layer of the printed circuit board 3, and bond with the second ground conductor portion 21. The signal pad 35 is provided on the first layer of the printed circuit board 3 and is electrically connected to one end of the signal wire 32.

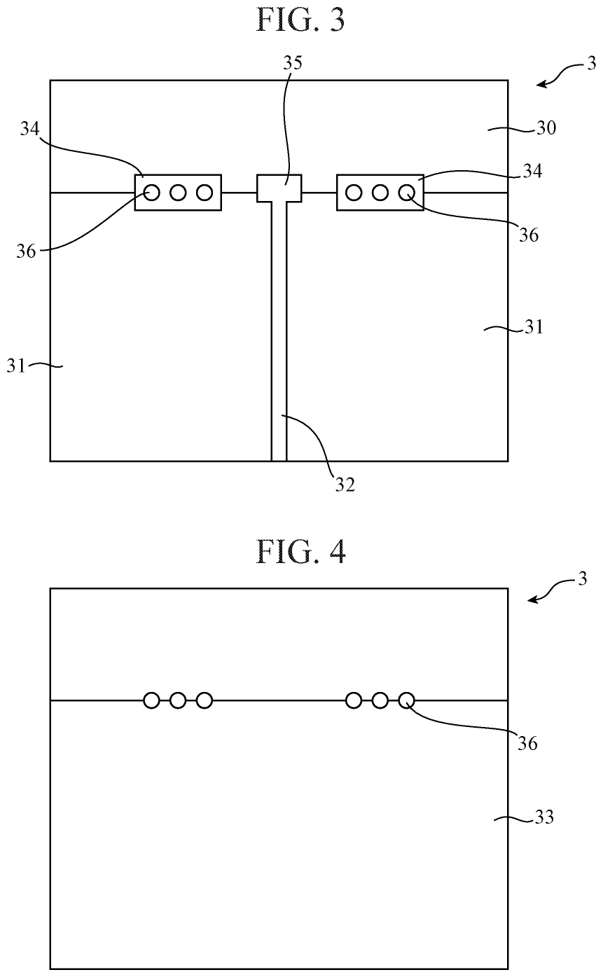

FIG. 3 is a plan view illustrating the printed circuit board 3 as seen in an arrow A direction in FIG. 2. FIG. 4 is a plan view illustrating the printed circuit board 3 as seen in an arrow B direction in FIG. 2. As illustrated in FIG. 3, the ground pads 34 and the signal pad 35 are provided on a boundary between the conductor-less area 30 and the wiring area 31.

Furthermore, as illustrated in FIGS. 3 and 4, the ground pads 34 are provided with ground vias 36 and are in electrical conduction with the base board ground 33 of the second layer through the ground vias 36.

FIGS. 3 and 4 illustrate a case where six ground vias 36 are provided in the printed circuit board 3 by providing each of two ground pads 34 with three ground vias 36, but no limitation thereto is intended. More specifically, it is sufficient that the base board ground 33 and the ground pads 34 can be electrically connected to each other, and the number of ground vias 36 may be equal to or larger than six or smaller than six.

As indicated by dashed arrows in FIG. 2, the coaxial connector 2 is provided so that lower surfaces of the second ground conductor portion 21 face the ground pads 34. At that time, the core wire 22 is brought into contact with the signal pad 35 in a state of being covered with the second ground conductor portion 21.

The lower surfaces of the second ground conductor portion 21 are bonding surfaces bonded to the ground pads 34, and are bonded to the ground pads 34 by soldering, for example. The core wire 22 is also bonded to the signal pad 35 by soldering.

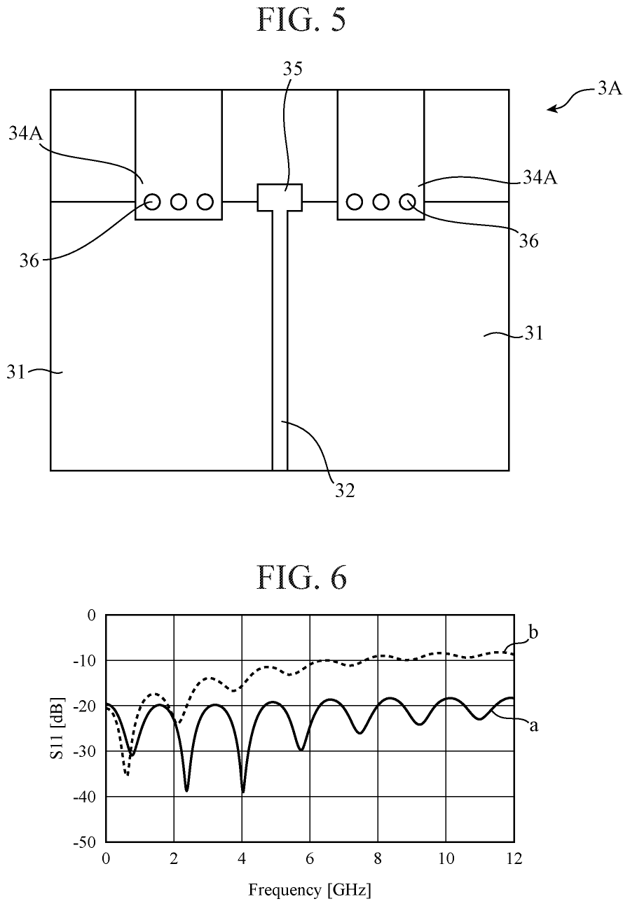

FIG. 5 is a plan view illustrating a state in which a printed circuit board 3A different from the printed circuit board 3 is seen in the arrow A direction in FIG. 2. In order to strengthen bonding between the coaxial connector 2 and the printed circuit board 3A, as illustrated in FIG. 5, ground pads 34A each having an increased bonding area with the lower surface of the second ground conductor portion 21 may be adopted.

Each of the ground pads 34 and 34A has an area equal to or smaller than that of the bonding surface (lower surface) of the second ground conductor portion 21. As a result of this configuration, a substantial distance between the second ground conductor portion 21 and the core wire 22 does not change, so that the coaxial connector 2 can be attached to the printed circuit board 3 without a change in a transmission characteristic of the base board module 1.

Herein, a case where the coaxial cable is connected to the coaxial connector 2 and the base board module 1 is used in communication of high frequency signals is described. It is assumed that a characteristic impedance of the coaxial cable matches a characteristic impedance of the signal wire 32 of the printed circuit board 3.

First, in order for reflection of the high frequency signal transmitted through the coaxial cable not to increase at the base board module 1, a characteristic impedance of the core wire 22 provided inside the first ground conductor portion 20 is designed so that the characteristic impedance matches the characteristic impedance of the coaxial cable.

The characteristic impedance of the core wire 22 provided inside the first ground conductor portion 20 is determined by a diameter of the core wire 22 and a distance between the first ground conductor portion 20 and the core wire 22.

The characteristic impedance of the coaxial cable is similarly determined by a diameter of a core wire of the coaxial cable and a distance between the core wire and an outer conductor provided around the core wire.

In a case of embedding a dielectric between the first ground conductor portion 20 and the core wire 22, a relative permittivity of the dielectric also affects the characteristic impedance, so that it is necessary to design in consideration of this.

A characteristic impedance of a portion of the core wire 22 is designed so that the characteristic impedance matches the characteristic impedance of the coaxial cable, the portion being covered with the second ground conductor portion 21.

Note that, when a dielectric is embedded inside the second ground conductor portion 21, a relative permittivity of the dielectric is also one of parameters in the design of the coaxial connector 2.

The characteristic impedance of the portion of the core wire 22, which is covered with the second ground conductor portion 21, is obtained, for example, by performing electromagnetic field analysis on cross-sectional structure of the second ground conductor portion 21 and the core wire 22 by using a two-dimensional electromagnetic field analysis tool.

In this manner, a characteristic impedance of the coaxial connector 2 is designed so that the characteristic impedance matches the characteristic impedance of the coaxial cable and the characteristic impedance of the signal wire 32 of the printed circuit board 3. As a result, it becomes possible to perform signal transmission without deterioration in an RF characteristic of the signal in the communication using the base board module 1.

FIG. 6 is a graph illustrating a relationship between a reflection characteristic (s11) and a frequency of a signal when the base board module is used in the communication of the high frequency signals. In FIG. 6, data assigned with reference sign a is a result of the electromagnetic field analysis of a relationship between the reflection characteristic and the frequency in the base board module 1 by using the two-dimensional electromagnetic field analysis tool. Data assigned with reference sign b is a result of the electromagnetic field analysis of a relationship between the reflection characteristic and the frequency in a conventional base board module by using the two-dimensional electromagnetic field analysis tool. Note that the conventional base board module is obtained by mounting a general-purpose SMA coaxial connector on a printed circuit board. As illustrated in FIG. 6, in the base board module 1, the characteristic thereof is improved by 10 dB at the maximum from that of the conventional base board module.

As described above, in the base board module 1 according to the first embodiment, the printed circuit board 3 includes the conductor-less area 30 in which the conductor is excluded over the entire edge on a side to which the coaxial connector 2 is attached. The end of the core wire 22 is brought into contact with the signal pad 35 in a state of being covered with the second ground conductor portion 21 of the coaxial connector 2 attached to the conductor-less area 30.

By configuring in this manner, detailed design of the printed circuit board 3 in consideration of an effect of the conductor of the edge of the printed circuit board 3 on the characteristic of the signal wire 32 can be omitted. For example, it is not required to design, on the printed circuit board 3, a structure for insulating a signal wire from a conductor in an edge area as in a dielectric layer of a quasi-coaxial transmission line disclosed in Patent Literature 1.

Furthermore, since signal transmission in which characteristic impedances of the coaxial cable, the coaxial connector 2, and the printed circuit board 3 are matched can be achieved just by design of the coaxial connector 2, the transmission characteristic can be kept good.

The base board module 1 according to the first embodiment is provided with the ground pads 34 or 34A which are provided on the first layer of the printed circuit board 3 and to which the second ground conductor portion 21 is bonded. Each of the ground pads 34 and 34A has an area equal to or smaller than that of the bonding surface of the second ground conductor portion 21.

As a result of this configuration, a substantial distance between the second ground conductor portion 21 and the core wire 22 does not change, so that the coaxial connector 2 can be attached to the printed circuit board 3 without a change in the transmission characteristic of the base board module 1.

### Second Embodiment

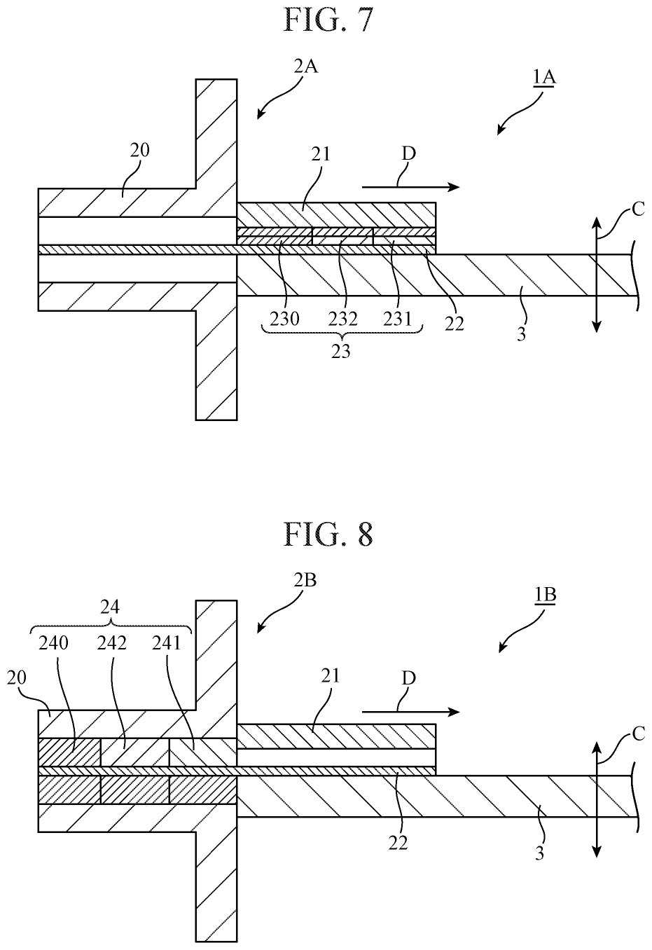

FIG. 7 is a cross-sectional view illustrating a base board module 1A according to a second embodiment of the present invention, illustrating a cross-section of the base board module 1A taken in an axial direction. The base board module 1A is provided with a coaxial connector 2A and a printed circuit board 3 as illustrated in FIG. 7.

Similar to the first embodiment, the coaxial connector 2A has a structure in which a conductor member including a first ground conductor portion 20 and a second ground conductor portion 21 surrounds a core wire 22, but a first dielectric portion 23 is provided inside the second ground conductor portion 21.

As illustrated in FIG. 7, the first dielectric portion 23 includes dielectrics 230 to 232 having different relative permittivities. The dielectric 230 has the smallest relative permittivity, and the dielectric 231 has the largest relative permittivity. The dielectric 232 has an intermediate relative permittivity between those of the dielectric 230 and the dielectric 231.

The dielectrics 230 to 232 are stacked (in two layers) in an arrow C direction orthogonal to the printed circuit board 3 inside the second ground conductor portion 21.

Furthermore, in a layer facing the printed circuit board 3 being a lowermost layer, the dielectrics 230 to 232 are provided in the axial direction. The dielectrics 230 to 232 are provided so that the relative permittivity gradually increases toward a tip end of an end of the core wire 22 as indicated by an arrow D.

More specifically, in the lowermost layer, the dielectric 230, the dielectric 232, and the dielectric 231 are provided in this order in an arrow D direction.

By adopting a structure in which the first dielectric portion 23 is provided inside the second ground conductor portion 21, electromagnetic field distribution of a signal transmitted from the coaxial connector 2A to the printed circuit board 3 is concentrated to the lowermost layer of each dielectric in the arrow D direction. As a result, a drastic change in electromagnetic field distribution from the second ground conductor portion 21 to the printed circuit board 3 is alleviated, and thus an RF characteristic of the connector more stable than that in the configuration of the first embodiment can be achieved.

Note that, although FIG. 7 illustrates a case where the first dielectric portion 23 includes the three types of dielectrics with different relative permittivities, no limitation thereto is intended. For example, two or more types of dielectrics are sufficient, and the number of types of dielectrics provided in each of a stacking direction (arrow C direction) and a direction of the core wire 22 (arrow D direction) may be two or more.

Although a structure in which the dielectrics 230 to 232 are stacked in the arrow C direction orthogonal to the printed circuit board 3 is illustrated, a structure in which the dielectrics 230 to 232 are stacked in a radial direction centered on the core wire 22 is also possible.

As described above, the base board module 1A according to the second embodiment is provided with the first dielectric portion 23.

The first dielectric portion 23 is configured so that the dielectrics 230 to 232 having different relative permittivities are stacked inside the second ground conductor portion 21 and the dielectrics 230 to 232 are provided in the axial direction in the lowermost layer. Especially, the dielectrics 230 to 232 are provided in the lowermost layer so that the relative permittivity gradually increases toward the tip end of the end of the core wire 22.

By configuring in this manner, a drastic change in electromagnetic field distribution from the second ground conductor portion 21 to the printed circuit board 3 is alleviated, and thus the RF characteristic of the connector more stable than that in the configuration of the first embodiment can be achieved.

### Third Embodiment

FIG. 8 is a cross-sectional view illustrating a base board module 1B according to a third embodiment of the present invention, illustrating a cross-section of the base board module 1B taken in an axial direction. The base board module 1B is provided with a coaxial connector 2B and a printed circuit board 3 as illustrated in FIG. 8.

Similar to the first embodiment, the coaxial connector 2B has a structure in which a conductor member including a first ground conductor portion 20 and a second ground conductor portion 21 surrounds a core wire 22, but a second dielectric portion 24 is provided inside the first ground conductor portion 20.

As illustrated in FIG. 8, the second dielectric portion 24 includes dielectrics 240 to 242 having different relative permittivities. The dielectric 240 has the smallest relative permittivity, and the dielectric 241 has the largest relative permittivity. The dielectric 242 has an intermediate relative permittivity between those of the dielectric 240 and the dielectric 241.

The dielectrics 240 to 242 are stacked (in two layers) in an arrow C direction orthogonal to the printed circuit board 3. Furthermore, in an uppermost layer, the dielectrics 240 to 242 are provided in the axial direction.

The dielectrics 240 to 242 are provided so that the relative permittivity gradually increases toward a tip end of an end of the core wire 22 as indicated by an arrow D. More specifically, in the uppermost layer, the dielectric 240, the dielectric 242, and the dielectric 241 are provided in this order in an arrow D direction.

By adopting a structure in which the second dielectric portion 24 is provided inside the first ground conductor portion 20, electromagnetic field distribution of a signal transmitted from a coaxial cable to the coaxial connector 2B is concentrated to the uppermost layer of each dielectric in the arrow D direction.

As a result, a drastic change in electromagnetic field distribution from the first ground conductor portion 20 to the second ground conductor portion 21 is alleviated, and thus an RF characteristic of the connector more stable than that in the configuration of the first embodiment can be achieved.

Note that, although FIG. 8 illustrates a case where the second dielectric portion 24 includes the three types of dielectrics with different relative permittivities, no limitation thereto is intended. For example, two or more types of dielectrics are sufficient, and the number of types of dielectrics provided in each of a stacking direction (arrow C direction) and a direction of the core wire 22 (arrow D direction) may be two or more.

Although a structure in which the dielectrics 240 to 242 are stacked in the arrow C direction orthogonal to the printed circuit board 3 is illustrated, a structure in which the dielectrics 240 to 242 are stacked in a radial direction centered on the core wire 22 is also possible.

As described above, the base board module 1B according to the third embodiment is provided with the second dielectric portion 24.

The second dielectric portion 24 is configured so that the dielectrics 240 to 242 having different relative permittivities are stacked inside the first ground conductor portion 20 and the dielectrics 240 to 242 are provided in the axial direction in the uppermost layer. Especially, the dielectrics 240 to 242 are provided in the uppermost layer so that the relative permittivity gradually increases toward the tip end of the end of the core wire 22.

By configuring in this manner, a drastic change in electromagnetic field distribution from the first ground conductor portion 20 to the second ground conductor portion 21 is alleviated, and thus the RF characteristic of the connector more stable than that in the configuration of the first embodiment can be achieved.

Note that although the configuration in which one of the first dielectric portion 23 and the second dielectric portion 24 is provided is heretofore described, a configuration in which both the first dielectric portion 23 and the second dielectric portion 24 are provided is also possible.

By configuring in this manner, the effects described in the second embodiment and the third embodiment can be obtained.

Note that, in the present invention, the embodiments may be freely combined, any component of each embodiment may be modified, or any component may be omitted in each embodiment without departing from the scope of the invention.

### INDUSTRIAL APPLICABILITY

The base board module according to the present invention is suitable for, for example, transmission of a high frequency signal because the structure of the printed circuit board can be simplified and the transmission characteristic can be kept good.

### REFERENCE SIGNS LIST

1, 1A, 1B Base board module
2, 2A, 2B Coaxial connector
3, 3A Printed circuit board
20 First ground conductor portion
21 Second ground conductor portion
22 Core wire
23 First dielectric portion
24 Second dielectric portion
30 Conductor-less area
31 Wiring area
32 Signal wire
33 Base board ground
34, 34A Ground pad
35 Signal pad
36 Ground via
230 to 232, 240 to 242 Dielectric

1. A base board module comprising:
a coaxial connector including a first ground conductor portion which is a cylindrical conductor member and an inside of which is provided with a core wire for a coaxial cable, and a second ground conductor portion which is a semi-cylindrical conductor member extending in an axial direction of the first ground conductor portion from the first ground conductor portion and covers an end of the core wire; and
a printed circuit board including a signal pad, a signal wire electrically connected to the signal pad, and a conductor-less area in which a conductor is excluded over an entire edge on a side to which the coaxial connector is attached;
wherein the coaxial connector is attached to the conductor-less area, and
the end of the core wire is brought into contact with the signal pad in a state of being covered with the second ground conductor portion of the coaxial connector attached to the conductor-less area.

2. The base board module according to claim 1, comprising:
a ground pad which is provided on the printed circuit board and to which the second ground conductor portion is bonded,
wherein the ground pad has an area equal to or smaller than that of a bonding surface of the second ground conductor portion.

3. The base board module according to claim 1, comprising:
a first dielectric portion in which a plurality of dielectrics having respective different relative permittivities is stacked inside the second ground conductor portion and a plurality of dielectrics having respective different relative permittivities is provided in the axial direction in a lowermost layer.

4. The base board module according to claim 1, comprising:
a second dielectric portion in which a plurality of dielectrics having respective different relative permittivities is stacked inside the first ground conductor portion and a plurality of dielectrics having respective different relative permittivities is provided in the axial direction in an uppermost layer.

5. The base board module according to claim 3,
wherein the plurality of dielectrics is provided so that a relative permittivity gradually increases toward a tip end of the end of the core wire in the lowermost layer.

6. The base board module according to claim 4,
wherein the plurality of dielectrics is provided so that a relative permittivity gradually increases toward a tip end of the end of the core wire in the uppermost layer.
